(19) United States
(12) Patent Application Publication
(10) Pub. No.: US 2016/0299918 A1
(43) Pub. Date: Oct. 13, 2016

(54) Device Control Using a Secure Decentralized Transactional Ledger

(71) Applicant: DELL SOFTWARE, INC., Round Rock, TX (US)

(72) Inventor: Daniel A. Ford, Mount Kisco, NY (US)

(73) Assignee: DELL SOFTWARE, INC., Round Rock, TX (US)

(21) Appl. No.: 14/680,242

(22) Filed: Apr. 7, 2015

(51) Int. Cl. G06F 17/30

(52) U.S. Cl. CPC G06F 17/30197

(57) ABSTRACT

A system, method, and computer-readable medium for providing a device control operation which enables a device to receive or otherwise identify commands intended for it by having the device consult and interact with a secure decentralized transactional ledger. Such a device control operation indirectly and securely controls a device. More specifically, in certain embodiments, the transactional ledger comprises a distributed data structure that is maintained by a set of unassociated network attached information handling systems. In certain embodiments, the network attached information handling systems use novel algorithms and cryptographic methods to ensure that the state of the ledger is valid and that it reflects the state endorsed by a predetermined number (e.g., a majority) of the information handling systems maintaining the ledger.

### BACKGROUND OF THE INVENTION

1. Field of the Invention

The present invention relates to information handling systems. More specifically, embodiments of the invention relate to device control using a secure decentralized transactional ledger.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to control a device (e.g., air conditioner, motor, smart phone, etc.) using information handling systems. In certain instances the devices themselves may also be information handling systems. It is often desirable to enable devices to operate independently and securely of any specific device command issuer such that the device need not be physically or logically, coupled to a single controller that directly issues commands to the device.

Such independent operation would make the devices more flexible, tolerant and adaptable to changes in their operating environment. For instance, many devices can have very long lives, and are placed in applications where they may be expected to be viable for decades (e.g., when embedded in infrastructure), the organizations that control them may not exist as long. Thus, having a communications framework that is not strictly reliant on a single authority (i.e., one that is decentralized) opens the possibility for long term communications and flexibility in further control. Accordingly, it is desirable to decouple the devices from any specific controller, thus enabling the devices to be semi-autonomous. Additionally, it is desirable to enable devices to be able switch their attention from one controller to another as the situation of the device dictates.

It is also known to use a decentralized transactional ledger to address efficient, probabilistic, solutions to the Byzantine Generals Problem and enable applications such as Crypto currencies (e.g., Bitcoin), and many others (e.g., smart contracts).

### SUMMARY OF THE INVENTION

A system, method, and computer-readable medium are disclosed for providing a device control operation which enables a device to receive or otherwise identify commands intended for it by having the device consult and interact with a secure decentralized transactional ledger. Such a device control operation indirectly and securely controls a device. More specifically, in certain embodiments, the transactional ledger comprises a distributed data structure that is maintained by a set of unassociated network attached information handling systems. In certain embodiments, the network attached information handling systems use novel algorithms and cryptographic methods to ensure that the state of the ledger is valid and that it reflects the state endorsed by a predetermined number (e.g., a majority) of the information handling systems maintaining the ledger.

In certain embodiments, the decentralized transactional ledgers contain data, such as commands to control devices, which can be examined by all, and their contents are (often probabilistically) known to be valid. The decentralized transactional ledgers are represented by a block chain that contains linked data representing the contents of the ledger. The block chain incorporates new entries in the ledger by being extended with additional blocks. In certain embodiments, the process of extending the block chain incorporates a consensus of multiple independent parties, such an extension process is extremely difficult to corrupt.

Device control is implemented by depositing commands into the decentralized transactional ledger such that the commands have appropriate addressing, are well formatted, and are recognized and decipherable by the intended recipient devices. The devices, in turn, monitor the contents of the ledger for commands addressed to them, from sources they are configured to obey, and execute the commands that they accept. The device can also use the ledger to generate a response (e.g., a return code) to the command by making its own entry into the ledger. This entry would then subsequently make its way back to the command source.

Accordingly, the secure decentralized transactional ledger serves as a distributed, reliable, platform independent, message passing framework. The devices are controlled by receiving messages contained in the ledger. Additionally, the exact format of the messages is not constrained by the ledger.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention.

FIG. 2 shows a simplified block diagram showing an implementation of a device control environment.

FIG. 3 shows a flow chart of the operation of a device control system.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

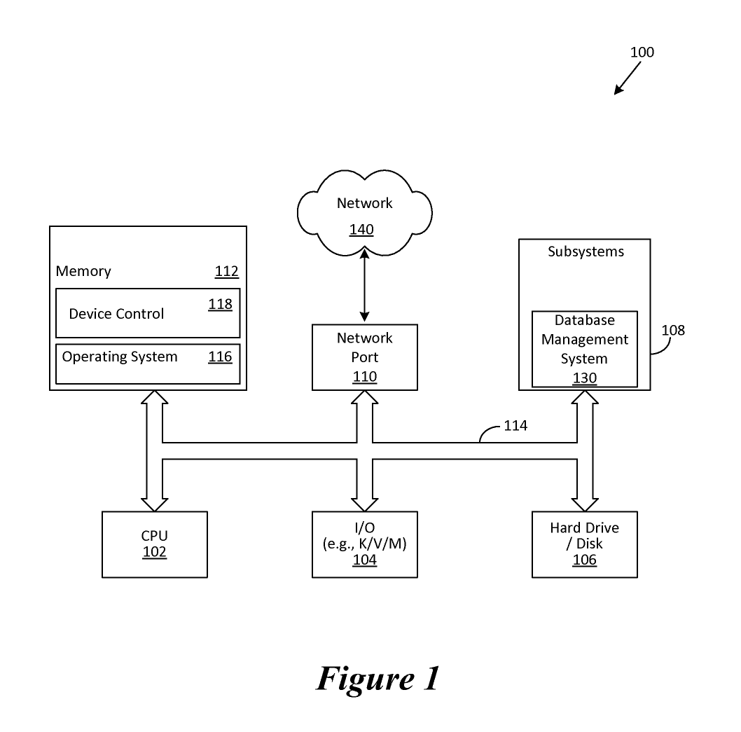

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise a device control module 118.

The device control module 118 provides a device control operation which enables a device to receive or otherwise identify commands intended for it by having the device consult and interact with a secure decentralized transactional ledger. Such a device control operation indirectly and securely controls a device. More specifically, in certain embodiments, the transactional ledger comprises a distributed data structure that is maintained by a set of unassociated network attached information handling systems. In certain embodiments, the network attached information handling systems use novel operations and cryptographic methods to ensure that the state of the ledger is valid and that it reflects the state endorsed by a predetermined number (e.g., a majority) of the information handling systems maintaining the ledger. For example, one operation is to allow extensions to the block chain in a manner that requires the machines maintaining the chain to demonstrate computational “proof-of-work” to produce a valid extension (i.e., to add another block to the chain), that requirement, coupled with the definition that the longest block chain is the (valid) “consensus state,” creates a significant barrier to creating and maintaining an (invalid) alternative. With the majority of (honest) machines working to extend the longest chain, the majority of computational resources are working to extend its length, and, thus, reinforcing its status as the consensus state. This means that for a “bad actor” to create and maintain an alternative, likely fraudulent, block chain state (i.e., a different, non-majority side branch with transactions favorable to them), it will need to muster computational resources that are at least equal to that maintaining the (majority) consensus to demonstrate equivalent proof-of-work; that objective will be extremely difficult to achieve without controlling more computers than exist in the majority.

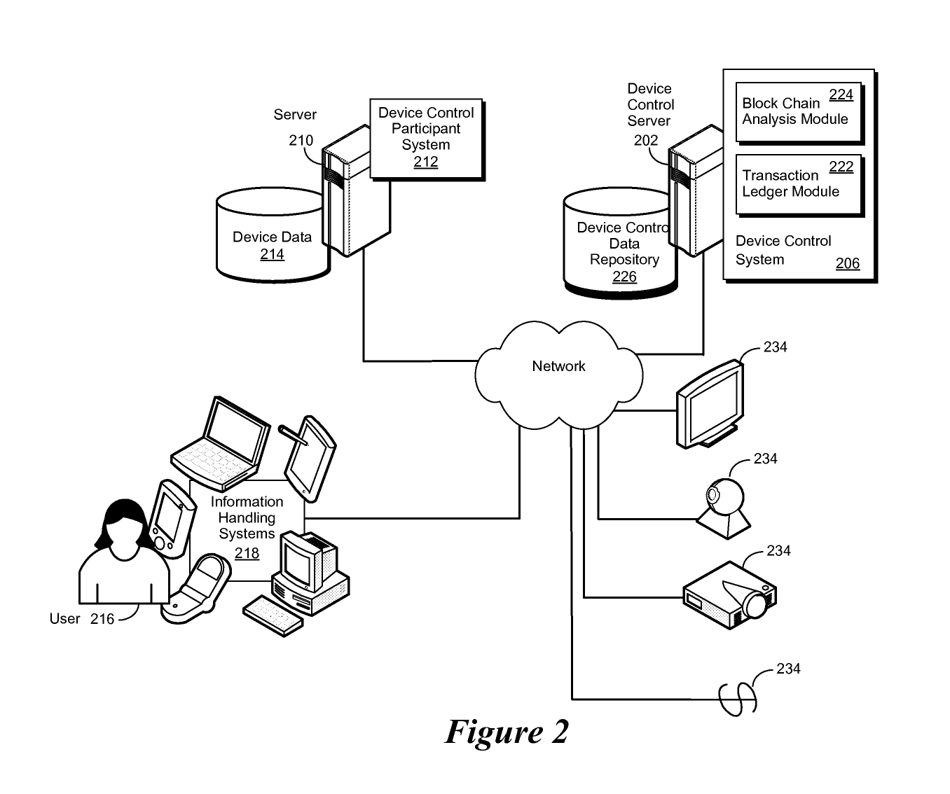

Referring to FIG. 2, a simplified block diagram showing an implementation of a device control environment 200 in accordance with an embodiment of the invention. The device control environment 200 includes a device control server 202 which includes a device control system 206. In certain embodiments, the device control system 206 comprises some or all of the device control module 118.

In certain of these embodiments, the device control system 206 comprises a transactional ledger module 222 and a block chain analysis module 224. In these and other embodiments, a user 216 uses an information handling system 218 to access a device control participant system 212, which is implemented on a server 210 and may access device data 214. As used herein, an information handling system 218 may comprise a personal computer, a laptop computer, or a tablet computer operable to exchange data between the user 216 and the server 210 over a connection to network 140. The information handling system 218 may also comprise a personal digital assistant (PDA), a mobile telephone, or any other suitable device operable to display a user interface (UI) 220 and likewise operable to establish a connection with network 140. In various embodiments, the information handling system 218 is likewise operable to establish a session over the network 140 with the device control system 206.

In this embodiment, device control operations are performed by the device control system 206 to control devices (such as device 234) which monitor the device control and is implemented by depositing commands into a decentralized transactional ledger via the transactional ledger module 222, such that the commands have appropriate addressing, are well formatted, and are recognized and decipherable by the intended recipient devices. The addressing of commands to devices can take multiple forms, but one form used in block chain type ledgers is to use 256-bit numbers as addresses. These addresses can be cryptographically significant, for instance serving as a “public key” as well as a unique address. If the address is also a public key, it can be used to encrypt the commands being recorded in the ledger, or be decrypted later by a device or devices with the matching private key. In addition, certain addresses may serve as “broadcast” addresses that are intended to send commands to groups of devices, while other addresses may be device specific. Any particular device could monitor and respond to multiple broadcast and multiple specific addresses. The addresses monitored and recognized by a device could even change over time as needed. The format and semantics of the commands are device class specific, and are expected to change over time as new conventions and standards evolve. To this end, conventions for identifying the nature and version of any particular commands stored in the ledger are included with the commands to facilitate their proper interpretation. The commands themselves may be numeric or textual codes, or even computer program code. In the latter case, the program can be executed on the device.

The devices 234, in turn, monitor the contents of the ledger for commands addressed to them, from sources they are configured to obey, and execute the commands that they accept. The devices 234 can also use the ledger to generate a response (e.g., a return code) to the command by making its own entry into the ledger. This entry would then subsequently make its way back to the command source. The production of a response to a command from a device, and its subsequent transmission back to the command issuer, or its designate, is determined by the nature of the command and the conventions being followed by the device; not all commands would invoke a response from a device that recognized, received and executed the commands. For those commands that do produce a response, that response is recorded in the ledger in a manner similar to that used for commands; data is stored in the ledger along with one or more addresses of the intended recipient; typically, but not necessarily, the original issuer of the command. In certain operations, the address of the device providing the response is also included with the purpose of identifying the responder, but this is not a requirement. As for commands, command responses are acquired by the recipient by monitoring the contents of the ledger and identifying stored data sets (i.e., responses) associated with an address they recognize. Again, as with commands, there can be multiple such addresses, some may be generally used, and some more specific, potentially as specific as to only be used for responses from a single device, though that is unlikely to be typical.

Accordingly, the secure decentralized transactional ledger serves as a distributed, reliable, platform independent, message passing framework. The devices are controlled by receiving messages contained in the ledger. Additionally, the exact format of the messages is not constrained by the ledger.

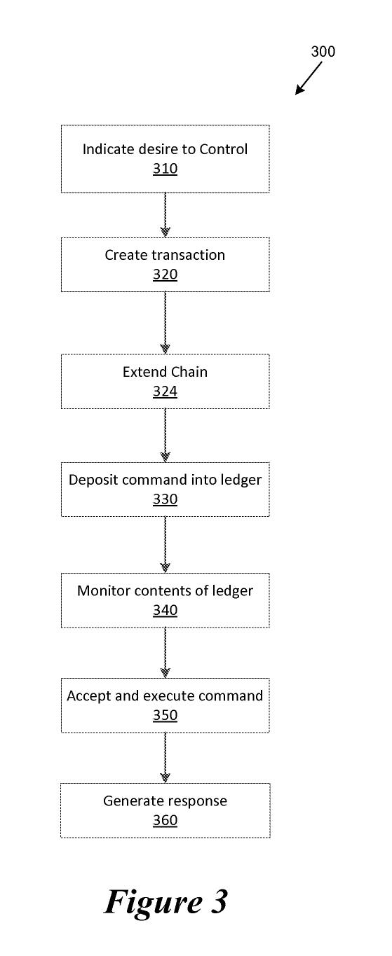

Referring to FIG. 3, a flow chart of a device control operation 300 of a device control system 206 is shown. The device control operation 300 enables a device to receive or otherwise identify commands intended for it by having the device consult and interact with a secure decentralized transactional ledger. Such a device control operation 300 indirectly and securely controls a device. The transactional ledger comprises a distributed data structure that is maintained by a set of unassociated network attached information handling systems. The network attached information handling systems use operations and cryptographic methods to ensure that the state of the ledger is valid and that it reflects the state endorsed by a predetermined number (e.g., a majority) of the information handling systems maintaining the ledger.

More specifically, the device control operation 300 begins operation at step 310 with a participant indicating a desire to control a device 234 within the environment 200. Next at step 320, the participant creates a transaction containing the command that has appropriate addressing, is well formatted, and is recognizable and decipherable by the intended recipient devices. That transaction is then submitted to the collective network of machines that maintain the ledger's contents by grouping such transactions into “blocks” and adding them to the existing block chain (performing the required proof-of-work defined by the ledger in order to achieve this). This collective eventually succeeds in forming such a block and the chain is extended at step 324, and the new block propagated throughout the network 140.

Next, at step 330, the device control system 206 deposits commands into the decentralized transactional ledger such that the commands have appropriate addressing, are well formatted, and are recognized and decipherable by the intended recipient devices. At step 340, the devices 234 monitor the contents of the ledger for commands addressed to them, from sources they are configured to obey. At step 350, a device to which a command is addressed accepts the command and executes the commands. Next, at step 360, the device 234 can also use the ledger to generate a response (e.g., a return code) to the command by making its own entry into the ledger. This entry would then subsequently make its way back to the command source. The response is recognized by the command issuer by an associated address that it recognizes.

Accordingly, the secure decentralized transactional ledger serves as a distributed, reliable, platform independent, message passing framework. The devices are controlled by receiving messages contained in the ledger. Additionally, the exact format of the messages is not constrained by the ledger.

The decentralized transactional ledgers contain data, such as commands to control devices, which can be examined by all, and their contents are (often probabilistically) known to be valid. The decentralized transactional ledgers are represented by a block chain that contains linked data representing the contents of the ledger. The block chain incorporates new entries in the ledger by being extended with additional blocks. The process of extending the block chain incorporates a consensus of multiple independent parties, such an extension process is extremely difficult to corrupt. The secure decentralized transactional ledgers contain data, such as commands to control devices, which can be examined by all, and their contents are (typically probabilistically) known to be valid. One way to implement such a ledger is through a data structure known as a block chain that links together blocks of such data organized into identifiable units called transactions; these transactions include addressing information. Such a chain of blocks is linked together by identifying each such block with a cryptographic checksum (typically SHA-256) of its contents (the transactions and additional metadata) that serves as each block's unique identifier. Links are formed by storing the cryptographic checksum identifier of one block in the metadata of other, such that the former becomes the predecessor of the latter. In this way, the blocks form a chain that can be navigated, from block-to-block, by retrieving the (cryptographic) checksum of a particular block's predecessor from the particular block's own metadata. In practice, it is often the computation of the “block identifying” cryptographic checksum, such that it conforms to a particular constraint (typically that it is numerically smaller than a particular value), that forms the proof-of-work required to add a block to the chain. In such block chain implementations, the machine performing the proof-of-work can manipulate a small, inconsequential, value specifically included in the block (i.e., the “nonce”) to influence the value of the checksum; this is a non-deterministic process, requiring a considerable amount of search, and, hence, is often difficult to compute. This makes it computationally “costly” to add blocks to the chain, making it difficult to corrupt given the need to “pay more” computation (and incur the real financial expense to do so) than a majority of machines also working to add (legitimate) blocks to the chain.

As used herein, a block chain refers to a transactional database shared by all nodes participating in a system. A full copy of a block chain contains every transaction ever executed in the system. With this information, the system one can determine a history of the data for each address at any point in the history of the block chain.

Every block includes a hash of the previous block. By including the hash, the block chain comprises a chain of blocks from a genesis block to the current block. Each block is guaranteed to come after the previous block chronologically because the previous block's hash would otherwise not be known. Each block is also computationally impractical to modify once it has been in the chain for a while because every block after it would also have to be regenerated. These are some of the properties of the block chain that allow the block chain to provide a secure means of controlling devices.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for controlling a device, comprising:
coupling the device with a secure transactional ledger;
depositing a command into the secure transactional ledger;
monitoring the secure transactional ledger for the command via the device;
accepting and executing the command via the device.

2. The method of claim 1, wherein:
the secure transactional ledger comprises a distributed data structure, the distributed data structure being maintained by a set of unassociated network attached information handling systems.

3. The method of claim 2, wherein:
the network attached information handling systems use cryptographic methods to ensure that the transactional ledger is valid and reflects a state endorsed by a predetermined number of the information handling systems maintaining the ledger.

4. The method of claim 1, wherein:
the decentralized transactional ledger comprises commands to control the device, the commands being examined by all devices coupled to the decentralized transactional ledger.

5. The method of claim 1, wherein:
the transactional ledger is represented by a block chain, the block chain comprising linked data representing the contents of the ledger, the block chain incorporates new commands in the transactional ledger by extending the block chain with additional blocks.

6. The method of claim 5, wherein:
extending the block chain incorporates a consensus of multiple independent parties.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
coupling the device with a secure transactional ledger;
depositing a command into the secure transactional ledger;
monitoring the secure transactional ledger for the command via the device;
accepting and executing the command via the device.

8. The system of claim 7, wherein:
the secure transactional ledger comprises a distributed data structure, the distributed data structure being maintained by a set of unassociated network attached information handling systems.

9. The system of claim 8, wherein:
the network attached information handling systems use cryptographic methods to ensure that the transactional ledger is valid and reflects a state endorsed by a predetermined number of the information handling systems maintaining the ledger.

10. The system of claim 7, wherein:
the decentralized transactional ledger comprises commands to control the device, the commands being examined by all devices coupled to the decentralized transactional ledger.

11. The method of claim 7, wherein:
the transactional ledger is represented by a block chain, the block chain comprising linked data representing the contents of the ledger, the block chain incorporates new commands in the transactional ledger by extending the block chain with additional blocks.

12. The method of claim 11, wherein:
extending the block chain incorporates a consensus of multiple independent parties.

13. A non-transitory, computer-readable storage medium embodying computer program code, the computer program code comprising computer executable instructions configured for:
coupling the device with a secure transactional ledger;
depositing a command into the secure transactional ledger;
monitoring the secure transactional ledger for the command via the device;
accepting and executing the command via the device.

14. The non-transitory, computer-readable storage medium of claim 13, wherein:
the secure transactional ledger comprises a distributed data structure, the distributed data structure being maintained by a set of unassociated network attached information handling systems.

15. The non-transitory, computer-readable storage medium of claim 14, wherein:
the network attached information handling systems use cryptographic methods to ensure that the transactional ledger is valid and reflects a state endorsed by a predetermined number of the information handling systems maintaining the ledger.

16. The non-transitory, computer-readable storage medium of claim 13, wherein:
the decentralized transactional ledger comprises commands to control the device, the commands being examined by all devices coupled to the decentralized transactional ledger.

17. The non-transitory, computer-readable storage medium of claim 13, wherein:
the transactional ledger is represented by a block chain, the block chain comprising linked data representing the contents of the ledger, the block chain incorporates new commands in the transactional ledger by extending the block chain with additional blocks.

18. The non-transitory, computer-readable storage medium of claim 17, wherein: extending the block chain incorporates a consensus of multiple independent parties.
